(19) United States
(12) Patent Application Publication
(10) Pub. No.: US 2014/0279286 A1
(43) Pub. Date: Sep. 18, 2014

(54) PORTABLE ADDRESS BOOK SYSTEMS AND RELATED METHODS

(71) Applicant: United Parcel Service of America, Inc., Atlanta, GA (US)

(72) Inventors: Bala Ganesh, Alpharetta, GA (US); Scott Castaldo, Woodstock, GA (US); Amber Reed, Atlanta, GA (US)

(21) Appl. No.: 14/215,409

(22) Filed: Mar. 17, 2014

Related U.S. Application Data
(60) Provisional application No. 61/786,437, filed on Mar. 15, 2013.

(51) Int. Cl. G06Q 30/06

(52) U.S. Cl. CPC G06Q 30/0641
USPC 705/27.1

(57) ABSTRACT

A portable, electronic address book is described. The address book enables the user to select various addresses from the address book, which are used to fill in address fields on webpages. The address book collects address information from various sources, including webpages (e.g., when a user fills in an address when making an online purchase) and social networks (e.g., from the user's social network profile) to be used to fill in address fields.

### CLAIM OF PRIORITY

This application claims the benefit of priority under 35 U.S.C. §119(e) to the filing date of U.S. Provisional Patent Application No. 61/786,437, filed Mar. 15, 2013, entitled, “Portable Address Book Systems and Related Methods,” which is incorporated herein by reference in its entirety.

### BACKGROUND

Shoppers frequently fill out web forms as part of the checkout process when making a purchase from an online retailer. These web forms usually include a variety of fields that a user is expected to fill in (such as shipping address, name, etc.), which may be substantially similar for each online checkout process. Entering the same information at each checkout can be tedious and perceived as a waste of time to the consumer.

Various embodiments of the present systems and methods recognize and address the foregoing considerations.

### SUMMARY

In general, a non-transitory computer-readable medium stores computer executable instructions for: 1) detecting an address field on a webpage associated with an online retailer; 2) at least partially in response to detecting the address field, displaying a user-selectable indicium adjacent to the address field; 3) receiving notification of a user selecting the user-selectable indicium; and 4) in response to receiving notification of the user selecting the user-selectable indicium, displaying an address book including one or more addresses associated with the user, wherein the one or more addresses associated with the user include at least one address collected from a social network associated with the user.

A computer system for populating an online address book includes at least one processor. The computer system, in various embodiments, is configured for: 1) receiving one or more browser-collected addresses associated with a purchase made by a user from an online retailer; 2) receiving one or more addresses from a social network that is associated with the user; 3) populating an address data repository with user address data; wherein the user address data includes the one or more browser-collected addresses and the one or more addresses received from the social network; 4) receiving a request to transmit the user address data to a client device; and 5) transmitting the user address data to the client device, wherein the client device enables the user to select a particular address from the user address data to populate an address field on a retail website.

A computer system for creating a portable online address book includes at least one processor. The computer system, according to particular embodiments is configured for: 1) receiving browser-collected address data including a first ship-to address for a purchase made by a first user from a first online retailer; 2) obtaining at least one ship-to address from social-network address data associated with the first user; 3) associating the first ship-to address and the at least one ship-to address with a first user address book associated with the first user; 4) receiving a request to send the first user address book to a client device; and 5) sending the first user address book to the client device for allowing a user of the client device to select an address from the first user address book to populate a ship-to field on a retail website.

### BRIEF DESCRIPTION OF THE DRAWINGS

Reference will now be made to the accompanying drawings, which are not necessarily drawn to scale, and wherein:

FIG. 1 is a block diagram of a Portable Address Book System according to various embodiments;

FIG. 2 is a block diagram of the Logistics Server of FIG. 1;

FIG. 3 shows a flow diagram that generally illustrates various steps executed by the exemplary Portable Address Book Module in FIG. 2 in accordance with various embodiments of the system of FIG. 1; and

FIG. 4 depicts a screenshot and description of various aspects and embodiments of the exemplary Portable Address Book Module of FIG. 2.

### DETAILED DESCRIPTION OF VARIOUS EMBODIMENTS

Various embodiments will be described more fully hereinafter with reference to the accompanying drawings. It should be understood that the invention may be embodied in many different forms and should not be construed as limited to the embodiments set forth herein. Like numbers refer to like elements throughout.

### System Overview

A computer system, according to various embodiments, is configured to provide users with a portable (e.g., online) address book. According to particular embodiments, the computer system is configured to: 1) detect an address field on a webpage; 2) display a link (e.g., a user-selectable indicium) near the address field; 3) receive notification of a user selecting the link; 4) display an address book comprising one or more addresses associated with the user; and 5) populate the address field on the webpage.

The portable address book may be provided through a browser plug-in/add-on, a social network, stand-alone software, a web-application, and/or a mobile application. Additionally, the portable address book may populate the address field with a shipping address, a billing address, credit card information, and/or other user data from a plurality of information that was collected and analyzed including, but not limited to: 1) user purchase data (e.g., online purchasing history); 2) real-time user input data (e.g., when filling out a web form); 3) user provided information data (e.g. entered into the portable address book or web form associated with the portable address book); 4) imported data from third party address books (e.g., Outlook® and/or Gmail® contacts); and/or 5) social network data.

Once there is sufficient address data, credit card data, and/or any other relevant data for use in the portable address book, the computer system may enable the user to access the portable address book at any time to automatically populate address information and purchasing fields when making online purchases. The computer system may allow the user to access the address book through a web login or browser add-on. In other embodiments, the computer system displays an indicium (e.g., a link) on a website and allows the user to access the address book by selecting the indicium.

In various embodiments, the computer system may be provided by a logistics company or any other suitable company that can access consumer data. Additionally, the system may be rendered on a user's computing device (e.g., laptop computer, desktop computer, mobile device, etc.), a company's servers, a social network server, a third party server (e.g., a retailer's server), or any combination of the forgoing.

### Exemplary Technical Platforms

As will be appreciated by one skilled in the relevant field, the present invention may be, for example, embodied as a computer system, a method, or a computer program product. Accordingly, various embodiments may be entirely hardware, entirely software, or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized, including, for example, hard disks, compact disks, DVDs, optical storage devices, and/or magnetic storage devices.

Various embodiments are described below with reference to block diagrams and flowchart illustrations of methods, apparatus (e.g., systems), and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, a special purpose computer, a smart mobile device, or another programmable data processing apparatus to produce a machine. As such, the instructions that execute on the general purpose computer, special purpose computer, smart mobile device, or other programmable data processing apparatus create means for implementing the functions specified in the flowchart block or blocks. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

FIG. 1 shows a block diagram of a Portable Address Book System 10 according to a particular embodiment. As may be understood from this figure, the Portable Address Book System 10 may include one or more Computer Networks 15, a Logistics Server 25, one or more Third Party Servers 35 (e.g., a web hosting server, retailer's server, any other server that hosts websites), a Social Network Server 45 (e.g., a sever associated with any social network), and one or more of the following: 1) a Mobile Computing Device 12 (e.g., a handheld computing device, a laptop computer, a smart phone, a tablet computer, or any other mobile computing device); and/or 2) a Desktop Computer 14.

The one or more Networks 15 facilitate communication between the Mobile Computing Device 12, Desktop Computer 14, Logistics Server 25, one or more Third Party Servers 35, and Social Network Server 45. These one or more Networks 15 may include any of a variety of types of computer networks such as the Internet, a private intranet, a public switch telephone network (PSTN), WAN, LAN, or any other type of suitable network. In certain variations of the embodiment shown in FIG. 1, the communication link between the Mobile Computing Device 12, the Desktop Computer 14, the Logistics Server 25, the one or more Third Party Servers 35, and/or the Social Network Server 45 may be implemented via the Internet using Internet Protocol (IP).

It should be understood that the Servers 25, 35, and 45 do not necessarily need to be deployed over the network. For example, in various embodiments, any or all of Severs 25, 35, and 45 may be deployed locally on the user's computer, tablet, and/or mobile device.

FIG. 2 shows a block diagram of an exemplary embodiment of an exemplary Logistics Server 25 that is configured for executing a Portable Address Book Module 300. It should be understood based on this disclosure that any suitable one or more computers (e.g., any of the computing devices shown in FIG. 1) may be used to execute this module and that various steps executed by the module may be executed on different computers.

The Logistics Server 25 may include one or more basic computer hardware components. As may be understood from FIG. 2, in this embodiment, the Logistics Server 25 includes a Processor 60 that communicates with other elements within the Logistics Server 25 via a System Interface or Bus 61. The Logistics Server 25 also includes a Display Device/Input Device 64 for receiving and displaying data. This Display Device/Input Device 64 may be, for example, a keyboard, voice recognition, or pointing device that is used in combination with a monitor. The Logistics Server 25 further includes a Memory 66, which preferably includes both a Read Only Memory (ROM) 65 and a Random Access Memory (RAM) 67. The server's ROM 65 may be used to store a Basic Input/Output System (BIOS) 26 that contains the basic routines that help to transfer information between elements within the Logistics Server 25.

Also located within the Logistics Server 25 is a Network Interface 74 for interfacing and communicating with other elements of a computer network. It will be appreciated by one of ordinary skill in the art that one or more components of the Logistics Server 25 may be located geographically remote from other components of the Logistics Server 25 and/or that certain components may be omitted from particular embodiments. Furthermore, one or more of the components may be combined, and additional components performing functions described herein may be included in the Logistics Server 25.

The Logistics Server 25 may also include at least one Storage Device 63, such as a hard disk drive, a floppy disk drive, a CD-ROM drive, or an optical disk drive, for storing information on various computer-readable media, such as a hard disk, a removable magnetic disk, or a CD-ROM disk. As will be appreciated by one of ordinary skill in the art, each of these Storage Devices 63 may be connected to the Bus 61 by an appropriate interface. The Storage Devices 63 and their associated computer-readable media may provide nonvolatile storage for the Logistics Server 25. It should be noted that the computer-readable media described above could be replaced by any other type of computer-readable media known in the art. Such media includes, for example, magnetic cassettes, flash memory cards, and digital video disks.

A number of program modules may be stored by the various storage devices and/or within the RAM 67. Such program modules include an Operating System 80 and the Portable Address Book Module 300. For simplicity and brevity, these modules are merely exemplary and may represent a number of program modules which control certain aspects of the operation of the Logistics Server 25 with the assistance of the Processor 60 and the Operating System 80. Exemplary embodiments of the Portable Address Book Module 300 are described in more detail below.

### Exemplary Portable Address Book Module

As shown in FIG. 2, certain embodiments of the Portable Address Book Module 300 are configured to gather and utilize consumer data to provide an online portable address book. The Portable Address Book Module 300 may operate alone or in combination with the Operating System 80 to perform the functions shown in FIG. 3. It should be understood by one skilled in the art that certain embodiments of the Portable Address Book Module 300 may perform the functions shown in FIG. 3 in an order other than the order shown in FIG. 3. It should also be understood that various systems, when executing the Portable Address Book Module 300, may omit particular functions or execute additional functions in performing the functions of the Portable Address Book Module 300.

### Exemplary Embodiment of the Portable Address Book Module Shown in FIG. 3

Detecting an Address Field

Beginning at Step 302, the Portable Address Book Module 300 detects an address field on a webpage associated with an online retailer. The system may be configured to detect an address field on a webpage associated with an online retailer using one or more suitable mechanisms. In various embodiments, the system is configured to detect the address field using a web browser plug-in installed on a client device associated with the user. In a particular embodiment, for example, the system is configured to detect the address field by examining the webpage's data in order to find the address field in the underlying code (e.g., the system parses the webpage). In other embodiments, the system is configured to use the web browser plug-in in any other suitable way to detect an address field on a webpage.

According to other embodiments, the user may indicate an address field on a webpage. In a particular example, the user, in response to seeing one or more address fields on a webpage, may indentify and notify the system of the one or more address fields by: 1) highlighting the one or more address fields with a pointer-device; 2) selecting the one or more address fields with a pointer-device; and/or 3) using any other suitable input mechanism to indicate one or more address fields on a webpage.

An address field on a webpage associated with an online retailer may be, for example, one or more fillable text fields on a webpage that enables the user (or another entity) to enter one or more addresses (e.g., to provide shipping and/or billing information to the online retailer). In various embodiments, the address field enables the user to enter one or more names, one or more shipping addresses, one or more shipping preferences, one or more phone numbers, and/or credit card information for one or more credit cards when making an online purchase with the online retailer.

The online retailer may be any online retailer. In various embodiments, the online retailer is a retailer that sells one or more various brands, but specializes in a specific type of merchandise (e.g., an online shoe retailer). In other embodiments, the online retailer specializes in one specific brand (e.g., Calvin Klein®). In still other embodiments, the online retailer is a general online retailer (e.g., Amazon®). In further embodiments, the online retailer specializes in services, group discounts, and/or whole sale items.

At Step 304, the system, at least partially in response to detecting the address field, displays a user-selectable indicium adjacent to the address field. The user-selectable indicium may take one or more forms. In various embodiments, the system is configured to display the indicium by adding a highlight to the address field (e.g., by adding a transparent yellow box around and/or in the address field). In other embodiments, the system displays the indicium as an underline of the address field. In further embodiments, the system displays the indicium by changing the color of the address field. In particular embodiments, the user-selectable indicium is displayed to the user as a symbol. The symbol may be, for example, a company logo, a registered trademark, and/or any other suitable symbol such as a heart, star, etc.

Additionally, the system may be configured to display the user-selectable indicium in one or more locations. In some embodiments, the user-selectable indicium is displayed to the right of the address field. In other embodiments, the user-selectable indicium is displayed below, above, or to the left of the address field. In further embodiments, the user-selectable indicium is displayed outside the webpage associated with the online retailer (e.g., in a separate window or bar of a web browser).

Continuing to Step 306, the system receives notification of a user selecting the user-selectable indicium. The system may enable the user to select the user-selectable indicium in any appropriate way. In various embodiments, the system enables the user to select the indicium using a mouse or other pointer device. In one such embodiment, the system enables the user to select the indicium by directing a cursor controlled by a pointer device (e.g., a mouse) over the indicium, then selecting the indicium (e.g., by pressing a select button on the mouse). In other embodiments, the system is configured to enable the user to select the indicium by directing a pointer device (e.g., a mouse) over the indicium. Here, the user “rolls over” the indicium to select it.

In other embodiments, the system is configured to enable the user to select the indicium without the use of a pointer device. In one embodiment, the system enables the user to select the indicium by highlighting or moving a cursor over the indicium with a keyboard and pressing the select key on the keyboard (e.g., by pressing “enter” on the keyboard). In another embodiment, the system enables the user to select the indicium on a touch-screen. In this embodiment, the user places their finger or stylist (or other appropriate touch-screen interfacing mechanism) over the indicium and selects it by pressing on the touch-screen.

Address Book and Collection of Addresses

At Step 308, in response to receiving notification of the user selecting the user-selectable indicium, the system displays an address book including one or more addresses associated with the user. In various embodiments, the address book includes one or more addresses associated with the user, including: 1) a first address associated with a purchase made from a first online retailer; and 2) at least one address collected from a social network address associated with the user.

The address book may be displayed to the user in one or more ways. In various embodiments, the system is configured to display the address book as a web-type browser pop-up window on a client device associated with the user. In other embodiments, the system displays the address book in a side bar of a web browser associated with the user. In further embodiments, the system displays the address book as part of a webpage displayed in a browser associated with a user. In still further embodiments, the system displays the address book at least partially based on the screen size or device displaying the address book (e.g., the display of the address book may vary if the user is on a tablet computer than if the user is on a desktop computer with a larger screen).

The address book, in various embodiments, is displayed in the same browser window as the browser window displaying the webpage on which the user selected the indicium (as described above). In various embodiments, the system is configured to display the address book adjacent to the address field on the webpage. In a particular embodiment, the system is configured to display the address book to the right or left of the address field. In other embodiments, the system is configured to display the address book above or below the address field.

The one or more addresses included in the address book may be arranged in one or more suitable ways. In various embodiments, the one or more addresses included in the address book are arranged in alphabetical order, based on the last name of the entity in the address (e.g., Smith, John is displayed before or above Tom, Joe). In other embodiments, the one or more addresses included in the address book are arranged in the order of use by the user. In a particular example, the one or more addresses that the user chooses most frequently to populate the address field (as described below) are displayed first. In further embodiments, the system is configured to arrange the one or more addresses in the address book in the order the one or more addresses were added to the address book (e.g., added by the user, or collected by the system as described below).

In various embodiments, the system is configured to enable the user to manually choose the arrangement of the one or more addresses included in the address book in any suitable way. According to particular embodiments, the system is configured to enable the user to manually choose the arrangement of the one or more addresses included in the address book by: 1) dragging one or more addresses to a new location (e.g., higher on the list, before other addresses) as visually displayed in the address book; and/or 2) choosing a method of ordering the one or more addresses from a predetermined set of one or more order options provided by the system and displayed in the address book (e.g., one or more options to sort and/or arrange the one or more addresses by date added, alphabetically, and/or by frequency of being chosen).

In various embodiments, the one or more addresses include a first address associated with a purchase made from a first online retailer. In a particular embodiment, the first address is, for example, the home address of the user, which the user entered on the website associated with the first retailer when making the purchase from the first online retailer. In various embodiments, the first address is a billing address associated with a method of payment used by the user to make the purchase on a website associated with the first online retailer. In other embodiments, the first address may be, for example: 1) the address of a friend of the first user entered into one or more address fields on the webpage associated with the first online retailer (e.g., so the one or more items of the purchase made on the website associated with the first online retailer would be shipped to the friend of the first user); and/or 2) the address of an entity where one or more parcels containing one or more items of the purchase on the website associated with the first online retailer were shipped.

The purchase made from the first online retailer may be any suitable product or service that can be purchased from an online retailer. In various embodiments, the purchase made from the first online retailer is for one or more items shipped to the user. In other embodiments, the purchase made from the first online retailer is one or more services that is not shipped to the user, but is represented by a coupon or other symbol (e.g., a bar code) the user may print to paper from a client device.

The first online retailer may be any suitable online retailer. In various embodiments, the first online retailer may be any of the retailers (or other retailers) described in Step 302. In a particular embodiment, the first online retailer is the same retailer as the online retailer in Step 302.

In various embodiments, the system may be configured to obtain the first address associated with a purchase made from a first online retailer in any suitable way. In a particular embodiment, the system collects the first address from a webpage associated with the first online retailer when the user is making the purchase from the first online retailer through a web browser plug-in installed on a client device associated with the user. In a particular embodiment, for example, the system is configured to detect an address field containing the first address by examining the webpage's data in order to find the first address in the underlying code (e.g., the system parses the webpage) and then collect the first address.

According to particular embodiments, the system is configured to obtain the first address from an email account associated with the user. In further embodiments, the system is configured to scan the code of the email account associated with the user to detect and collect data associated with the first address. In further embodiments, the first address is collected when the user sends a confirmation email for the purchase to the system or to an email account that the system is configured to access. In still further embodiments, the first address is collected through an add-on which has been installed on an email client (e.g., Outlook®) associated with an email account of the user.

In other embodiments, the system is configured to receive the first address from the first online retailer. According to particular embodiments, the system is configured to receive the first address from the servers associated with the first online retailer (e.g., the one or more Third Party Servers 35). In further embodiments, the system is configured to receive the first address from the first online retailer via an appropriate application programming interface (API) associated with the first online retailer.

In various embodiments the one or more addresses include at least one address collected from a social network associated with the user. The at least one address collected from the social network may be any suitable address from the social network. In a particular embodiment, the at least one address is an address of the user that the user has posted on the social network. In other embodiments, the at least one address is an address of a person associated with the user on the social network (e.g., a “friend” on Facebook®).

In various embodiments, the addresses are validated by a logistic company or third party software. In a particular example, the system collects and/or receives the first address associated with a purchase made from a first online retailer and then submits the first address to address validation software associated with a logistics company. Continuing with this example, the validation software then checks the first address against a database of all the addresses in the area, country, and/or region.

Returning to Step 310, the system enables the user to select the one or more addresses of the address book. In various embodiments, the user may, for example, select the one or more addresses of the address book in any of the same ways (or other ways) the user may select the user-selectable indicium in Step 306.

Selecting an Address and Populating the Address Field

At Step 312, the system receives notification that the user has selected the one or more addresses. The system may be configured, in various embodiments, to receive notification that the user has selected the one or more addresses in the same way (or other ways) as the system is configured to receive notification of the user selecting the user-selectable indicium in Step 306.

At Step 314, the system, in response to the receiving notification that the user has selected the one or more addresses, populates the address field on the webpage associated with the first online retailer with the selected one or more addresses of the address book. The system may be configured to populate the address field with the selected one or more addresses of the address book in one or more suitable ways. In various embodiments, the system is configured to populate the address field with the selected one or more addresses of the address book by pasting the address in from a database associated with an account of the user (e.g., using a browser add-on to paste the alphanumeric characters of the selected address into the address field of the webpage). According to particular embodiments, the system is configured to populate the address field with the selected one or more addresses of the address book using an API to transmit the selected address of the user to the online retailer. In further embodiments, the system is configured to scan the webpage and add the selected one or more addresses of the address book (e.g., the system adds the selected one or more addresses through code representing the alphanumeric characters of the selected one or more addresses).

### Exemplary Portable Address Book User Experience

FIG. 4 depicts: 1) an exemplary webpage 400 that is part of an online checkout process; 2) a portable address book 406; and 3) various components of the webpage and portable address book. The webpage 400, as depicted, includes address fields 402, user-selectable indicium 404, and other elements. The portable address book 406 includes address button 408, collected addresses 410, and address modification options 412.

According to the embodiment in FIG. 4, the system (as described above) detects the address fields 402, which may include, for example, fields for a user's first name, last name, address, city, state, ZIP code, and/or phone number. At least partially in response to detecting the address fields 402, the system, in this example, is configured to display the user-selectable indicium 404.

In a particular embodiment, the user selects the user-selectable indicium by, for example, clicking or rolling-over the indicium. In response to the user selecting the indicium, the system displays the portable address book 406. The portable address book 406, in this particular example, displays several user addresses (e.g., the collected addresses 410, which may be collected, for example, via any of the ways described in Step 308), which the user may select to populate one or more of the address fields 402. In this example, the user selects the address button 408 corresponding to the address (e.g., the collected addresses 410) the user desires to use to fill in the one or more address fields 402. As shown in FIG. 4, the system has filled in the address information associated with the top left address of the portable address book 406 (e.g., the address associated with “Tom Frisco”). As can be seen in this particular figure, the information for “Tom Frisco” has been populated in the address fields 402. The portable address book 406, in this example, also includes address modification options 412, which may enable a user to modify, add, and/or delete an address included with the portable address book.

### Alternate Embodiments

Alternative embodiments of the system may comprise features that are, in some respects, similar to the various components described above. Selected distinguishing features of these alternative embodiments are discussed below. For example, in various embodiments, the system may be configured to enable a user to populate an address field on a retailer website by selecting a user-selectable indicium on the retailer website. In particular embodiments, the system is configured to substantially automatically (e.g. automatically) populate the address field in response to the user selecting the user-selectable indicium. According to further embodiments, the system is configured to enable the retailer to populate the address field through an appropriate API.

### CONCLUSION

Many modifications and other embodiments of the present systems and methods will come to mind to one skilled in the art having the benefit of the teachings presented in the foregoing descriptions and associated drawings. Therefore, it is to be understood that the present systems and methods are not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A non-transitory computer-readable medium storing computer executable instructions for:
(A) detecting an address field on a webpage associated with an online retailer;
(B) at least partially in response to detecting the address field, displaying a user-selectable indicium adjacent to the address field;
(C) receiving notification of a user selecting the user-selectable indicium; and
(D) in response to receiving notification of the user selecting the user-selectable indicium, displaying an address book comprising one or more addresses associated with the user, wherein the one or more addresses associated with the user comprise at least one address collected from a social network associated with the user.

2. The non-transitory computer-readable medium of claim 1, wherein the computer-readable medium further stores instructions for:
(A) enabling the user to select the one or more addresses of the address book;
(B) receiving notification that the user has selected the one or more addresses; and
(C) at least partially in response to the receiving notification that the user has selected the one or more addresses, populating the address field on the webpage associated with the online retailer with the selected one more addresses of the address book.

3. The non-transitory computer-readable medium of claim 2, wherein the one or more addresses associated with the user further comprise at least one address selected from a group consisting of:
(A) an address collected from a webpage associated with an online retailer;
(B) an address collected from an email account associated with the user;
(C) an address received from the user; and
(D) an address transmitted by an online retailer.

4. The non-transitory computer-readable medium of claim 3, wherein the one or more address associated with the user further comprises the address collected from the webpage associated with the online retailer.

5. The non-transitory computer-readable medium of claim 4, wherein the address collected from the webpage is collected by:
(A) detecting the user is making a purchase from the online retailer; and
(B) at least partially in response to detecting the user making the purchase, collecting the address.

6. The non-transitory computer-readable medium of claim 5, wherein the computer-executable instructions are adapted for execution by a processor as an add-on to a web browser.

7. The non-transitory computer-readable medium of claim 6, wherein the at least one address collected from the social network is validated by a logistics company.

8. The non-transitory computer-readable medium of claim 4, wherein the address book further comprises data selected from a group consisting of:
(A) credit card data associated with the user;
(B) shipping preference data associated with the user; and
(C) billing address data associated with the user.

9. The non-transitory computer-readable medium of claim 3, wherein:
(A) the one or more addresses associated with the user further comprise at least one address transmitted by an online retailer; and
(B) the at least one address transmitted by the online retailer is transmitted via an application programming interface.

10. The non-transitory computer-readable medium of claim 9, wherein the at least one address transmitted by the online retailer is validated by a logistics company.

11. The non-transitory computer-readable medium of claim 3, wherein:
(A) the one or more addresses associated with the user further comprise at least one address received from the user; and
(B) the at least one address received from the user comprises an address entered by the user into a web form.

12. The non-transitory computer-readable medium of claim 11, wherein the at least one address received from the user is validated by a logistics company.

13. A computer system for populating an online address book comprising:
at least one processor, wherein the computer system is configured for:
(A) receiving one or more browser-collected addresses associated with a purchase made by a user from an online retailer;
(B) receiving one or more addresses from a social network that is associated with the user;
(C) populating an address data repository with user address data; wherein the user address data comprises the one or more browser-collected addresses and the one or more addresses received from the social network;
(D) receiving a request to transmit the user address data to a client device; and
(E) transmitting the user address data to the client device, wherein the client device enables the user to select a particular address from the user address data to populate an address field on a retail website.

14. The computer system of claim 13, wherein receiving the request to transmit the user address data to the client device comprises receiving a notification that the user has selected a user-selectable indicium that is adjacent the address field on the retail website.

15. The computer system of claim 13, wherein the computer system is further configured for:
receiving one or more addresses selected from a group consisting of:
(A) an address from a web form filled by the user;
(B) an address from an email client associated with the user;
(C) an address from an online service associated with a logistics company; and
(D) an address from a third party associated with the user.

16. The computer system of claim 15, wherein the computer system is further configured for receiving one or more addresses from an email client associated with the user.

17. The computer system of claim 16, wherein the one or more addresses from the email client associated with the user are collected by the email client via a browser add-on.

18. The computer system of claim 16, wherein the one or more addresses from the email client associated with the user are collected by scraping email associated with the email client.

19. The computer system of claim 15, wherein the computer system is further configured to validate each address of the user address data using address validation software associated with a logistics company.

20. The computer system of claim 13, wherein the address data repository is a portable user address book.

21. The computer system of claim 13, wherein the computer system is associated with a logistics company.

22. A computer system for creating a portable online address book comprising:
at least one processor, the computer system configured for:
(A) receiving browser-collected address data comprising a first ship-to address for a purchase made by a first user from a first online retailer;
(B) obtaining at least one ship-to address from social-network address data associated with the first user;
(C) associating the first ship-to address and the at least one ship-to address with a first user address book associated with the first user;
(D) receiving a request to send the first user address book to a client device; and
(E) sending the first user address book to the client device for allowing a user of the client device to select an address from the first user address book to populate a ship-to field on a retail website.

23. The computer system of claim 22, wherein receiving browser-collected address data is chosen from a group consisting of:
(A) address data from another electronic address book;
(B) address data entered into a web form;
(C) address data from a third party; and
(D) address data scraped from an email account associated with the first user.

24. The computer system of claim 22, wherein obtaining at least one ship-to address from social-network data comprises receiving the at least one ship-to address from the social network.

25. The computer system of claim 22, wherein:
(A) obtaining at least one ship-to address from social-network data comprises receiving the at least one ship-to address via an application programming interface associated with the social network; and
(B) the at least one ship-to address is an address at least partially associated with a profile on the social network associated with the first user.

26. The computer system of claim 22, wherein receiving the request to send the first user address book to the client device further comprises receiving notification that a user has accessed a user-selectable indicium displayed on a web page adjacent to a shipping field.

27. The computer system of claim 26, wherein the shipping field comprises a field on the webpage wherein a particular ship-to address is entered.
